(19) United States
(12) Patent Application Publication
(10) Pub. No.: US 2024/0420444 A1
(43) Pub. Date: Dec. 19, 2024

(54) IMAGE READING DEVICE, IMAGE FORMING APPARATUS, AND IMAGE PROCESSING METHOD

(71) Applicant: Takayuki Saitoh, Kanagawa (JP)

(72) Inventor: Takayuki Saitoh, Kanagawa (JP)

(73) Assignee: Ricoh Company, Ltd., Tokyo (JP)

(21) Appl. No.: 18/659,931

(22) Filed: May 9, 2024

(30) Foreign Application Priority Data
Jun. 14, 2023 (JP) 2023-098126

(51) Int. Cl. G06V 10/44; G06T 3/60

(52) U.S. Cl. CPC G06V 10/44; G06T 3/60

(57) ABSTRACT

An image reading device includes a memory and an image processing circuit that receives, from an image sensor, read images including a front image and a rear image for each of pages of a read document. The memory has a first area for storing the front image and a second area for storing the rear image. The image processing circuit includes a first circuit that performs first image processing on one of the front image and the rear image and alternately stores, for each of the pages, the front image in the first area and the rear image in the second area and a second circuit that performs second image processing on the one of the front image and the rear image read from the memory. The image processing circuit performs, in parallel, writing the read images to the memory and reading the read images from the memory.

### CROSS-REFERENCE TO RELATED APPLICATION

This patent application is based on and claims priority pursuant to 35 U.S.C. § 119 (a) to Japanese Patent Application No. 2023-098126, filed on Jun. 14, 2023, in the Japan Patent Office, the entire disclosure of which is hereby incorporated by reference herein.

### BACKGROUND

### Technical Field

Embodiments of this disclosure relate to an image reading device, an image forming apparatus, and an image processing method.

### Related Art

There is a technique used in image processing of a multifunction peripheral/printer/product (MFP). According to the technique, an image processing unit of the MFP performs image processing on the images of the front and rear sides of a document (mainly to remove characteristics of a reading unit of the MFP from the images). The processed images of the front and rear sides are then stored in a buffer memory capable of storing the image of one page corresponding to the front side and the image of one page corresponding to the rear side (i.e., the images of two pages corresponding to the front and rear sides). Then, in accordance with the data to be output, image processing is alternately performed on the images of the front and rear sides each as image data of one page.

### SUMMARY

In one embodiment of this invention, there is provided an image reading device that includes, for example, an image processing circuit and a memory. The image processing circuit receives a plurality of read images input from an image sensor. The plurality of read images includes a front-side image and a rear-side image for each page of a plurality of pages of a document read by the image sensor. The memory has a first memory area for storing the front-side image and a second memory area for storing the rear-side image. The image processing circuit includes a first image processing circuit and a second image processing circuit. The first image processing circuit performs first image processing on one of the front-side image and the rear-side image, and alternately stores, for each of the plurality of pages of the document, the front-side image in the first memory area and the rear-side image in the second memory area. The second image processing circuit performs second image processing on the one of the front-side image and the rear-side image on which the first image processing is performed and read from the memory. The image processing circuit performs, in parallel, writing the plurality of read images on which the first image processing is performed to the memory and reading the plurality of read images from the memory to perform the second image processing on the plurality of read images.

In one embodiment of this invention, there is provided an image forming apparatus that includes, for example, the above-described image reading device and an image forming device to form an image based on each of the plurality of read images.

In one embodiment of this invention, there is provided an image processing method that includes, for example, receiving a plurality of read images input from an image sensor. The plurality of read images includes a front-side image and a rear-side image for each of a plurality of pages of a document read by the image sensor. The image processing method further includes performing first image processing on one of the front-side image and the rear-side image, and alternately storing, for each of the plurality of pages of the document, the front-side image and the rear-side image in a memory having a first memory area that stores the front-side image and a second memory area that stores the rear-side image. The image processing method further includes performing second image processing on the one of the front-side image and the rear-side image on which the first image processing is performed and read from the memory, and performing, in parallel, writing the plurality of read images on which the first image processing is performed to the memory and reading the plurality of read images from the memory to perform the second image processing on the plurality of read images.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a schematic configuration of an image reading device of an image forming apparatus according to a first embodiment of the present invention, as viewed from a front side of the image reading device;

FIG. 2 is an enlarged view of a schematic configuration of a sheet-through document feeder (SDF) included in the image reading device of the first embodiment, as viewed from a front side of the SDF;

FIG. 3 is a block diagram illustrating a hardware configuration of the image forming apparatus of the first embodiment;

FIG. 4 is a diagram illustrating an example of an operational overview of a background-art image reading device in a reading process;

FIG. 5 is a diagram illustrating another example of the operational overview of the background-art image reading device in the reading process;

FIG. 6 is a timing chart illustrating an operation of the background-art image reading device in the reading process;

FIG. 7 is a diagram illustrating an example of an operational overview of the image reading device of the first embodiment in a reading process;

FIG. 8 is a diagram illustrating another example of the operational overview of the image reading device of the first embodiment in the reading process;

FIG. 9 is a timing chart illustrating an operation of the image reading device of the first embodiment in the reading process;

FIG. 10 is a diagram illustrating an example of the operational overview of the image reading device according to a second embodiment of the present invention in the reading process;

FIG. 11 is a diagram illustrating another example of the operational overview of the image reading device of the second embodiment in the reading process;

FIG. 12 is a timing chart illustrating an operation of the image reading device of the second embodiment in the reading process;

FIG. 13 is a diagram illustrating an example of the operational overview of the background-art image reading device in a front-side reading process;

FIG. 14 is a diagram illustrating another example of the operational overview of the background-art image reading device in a rear-side reading process;

FIG. 15 is a timing chart illustrating an operation of the background-art image reading device in the reading process;

FIG. 16 is a diagram illustrating an example of the operational overview of the image reading device according to a third embodiment of the present invention in the reading process;

FIG. 17 is a timing chart illustrating an operation of the image reading device of the third embodiment in the reading process;

FIG. 18 is a diagram illustrating an example of the operational overview of the image reading device according to a fourth embodiment of the present invention in the reading process;

FIG. 19 is a timing chart illustrating an operation of the image reading device of the fourth embodiment in the reading process;

FIG. 20 is a timing chart illustrating an operation of a comparative example in which a toggle buffer of the image reading device of the fourth embodiment is replaced by a single buffer as in the background-art image reading device;

FIG. 21 is a diagram illustrating an example of the operational overview of the image reading device according to a fifth embodiment of the present invention in the reading process;

FIG. 22 is a timing chart illustrating an operation of the image reading device of the fifth embodiment in the reading process;

FIG. 23 is a timing chart illustrating an operation of a comparative example in which a toggle buffer of the image reading device of the fifth embodiment is replaced by a single buffer as in the background-art image reading device;

FIG. 24 is a diagram illustrating an example of the operational overview of the image reading device according to a sixth embodiment of the present invention in the reading process;

FIG. 25 is a diagram illustrating an example of the operational overview of the image reading device according to a seventh embodiment of the present invention in the reading process;

FIG. 26 is a diagram illustrating an example of the operational overview of the image reading device according to an eighth embodiment of the present invention in the reading process;

FIG. 27 is a timing chart illustrating an operation of the image reading device of the eighth embodiment in the reading process; and

FIG. 28 is a timing chart illustrating an operation of a comparative example in which toggle buffers of the image reading device of the eighth embodiment are replaced by single buffers as in the background-art image reading device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, an image reading device, an image forming apparatus, and an image processing method according to embodiments of the present disclosure are described in detail below. As used herein, the singular forms “a,” “an,” and “the” are intended to include the plural forms as well, unless the context clearly indicates otherwise.

In the embodiments, an image forming apparatus commonly called multifunction peripheral/printer/product (MFP) with at least two functions out of a copier function, a printer function, a scanner function, and a facsimile (FAX) function is described as an example. A first embodiment of the present invention will be described.

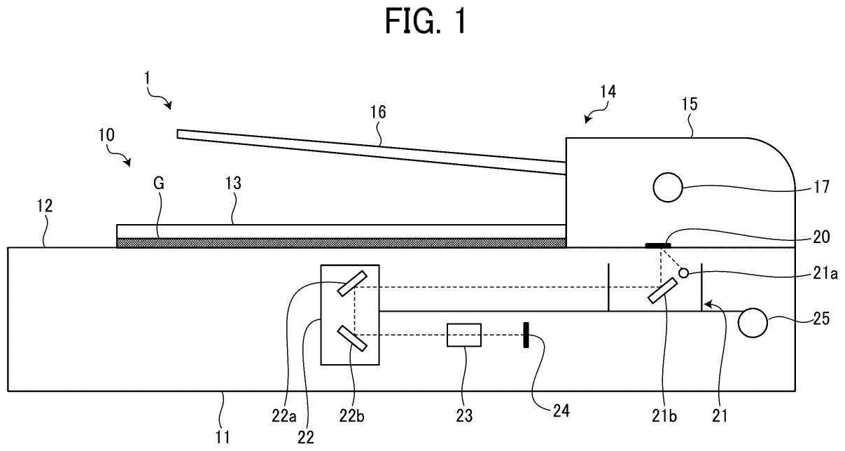

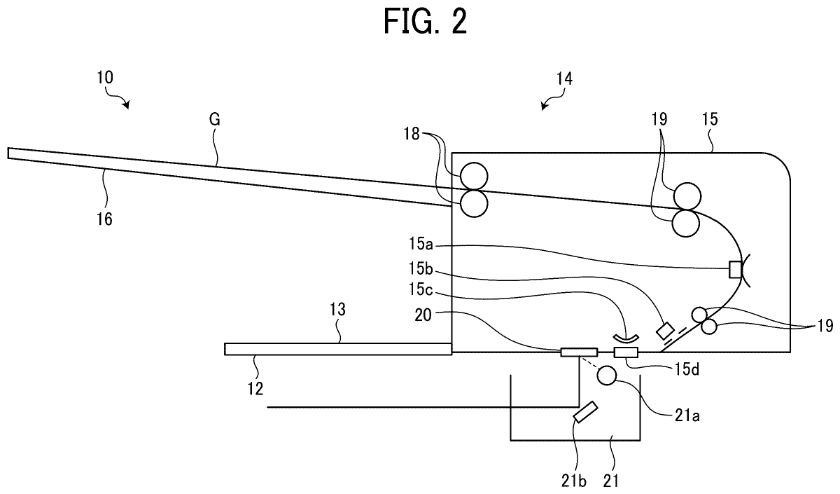

FIG. 1 is a diagram illustrating a schematic configuration of an image reading device 10 of an image forming apparatus 1 according to the first embodiment, as viewed from the front side of the image reading device 10. FIG. 2 is an enlarged view of a schematic configuration a sheet-through document feeder (SDF) 15 of the image reading device 10, as viewed from the front side of the SDF 15.

As illustrated in FIG. 1, the image forming apparatus 1 includes the image reading device 10 (e.g., a scanner). The image reading device 10 includes a document reading table (document table) 12 on an upper portion of a housing 11. The document reading table 12 is typically equipped with a contact glass. An upper portion of the document reading table 12 includes an openable and closable document holder cover 13. A document G is set on the document reading table 12, and the document holder cover 13 is closed to press the document G in close contact with the contact glass of the document reading table 12.

Further, as illustrated in FIG. 1, an upper-right portion of the housing 11 includes a document transport device 14. The document transport device 14 includes the SDF 15 and a document tray 16. The SDF 15 includes therein a document transport stepping motor 17. A stack of a plurality of documents G is placed face up on the document tray 16.

With the document transport stepping motor 17, the document transport device 14 drives and rotates separation rollers 18 and transport rollers 19 provided inside the SDF 15, as illustrated in FIG. 2. With the separation rollers 18 driven and rotated, the SDF 15 separates each of the documents G on the document tray 16 from the other documents G. Then, with the transport rollers 19 driven and rotated, the SDF 15 transports the thus-separated document G through a document transport path inside the SDF 15 onto the document reading table 12 and then onto a sheet ejection tray.

The SDF 15 includes a contact image sensor (CIS) 15a, a pair of photosensors 15b, and a white plate 15c, for example, along the document transport path.

The CIS 15a is a reading device that reads the image of the rear side of the document G transported on the document transport path.

Document reading mode of the image reading device 10 includes book mode and SDF mode. The following description will be given of the SDF mode in a simultaneous two-side reading process.

As illustrated in FIG. 2, when the plurality of documents G are set on the document tray 16, the image reading device 10 turns on a light source 21a to read a white reference plate 20, and drives the document transport stepping motor 17. The image reading device 10 moves a first carriage 21 to a reading position, i.e., the position of an SDF window 15d, and stops the first carriage 21 at the reading position. The image reading device 10 then drives the document transport stepping motor 17 to separate one of the documents G set on the document tray 16 from the other documents G with the separation rollers 18. Then, the image reading device 10 transports the thus-separated document G at a fixed velocity (i.e., constant velocity) with the transport rollers 19, and the reads the image of the rear side of the document G with the CIS 15a. After the reading of the rear side of the document G, the image reading device 10 transports the document G at a fixed velocity (i.e., constant velocity) to the position of the SDF window 15d, i.e., the particular reading position of the first carriage 21.

The image reading device 10 further transports the document G at the fixed velocity (i.e., constant velocity), and irradiates the transported document G with light from the light source 21a of the first carriage 21 through the SDF window 15d, with the first carriage 21 and a second carriage 22 being stopped at respective reading positions. The image reading device 10 then causes the light reflected from the document G to be reflected through the SDF window 15d by a mirror 21a of the first carriage 21 and mirrors 22a and 22b of the second carriage 22 and be incident on a charge coupled device (CCD) 24 through a lens 23. The CCD 24 performs photoelectric conversion on the reflected light to read the image of the front side of the document G. That is, the CCD 24 is a reading device that reads the image of the front side of the document G transported on the document transport path. The first carriage 21 and the second carriage 22 are driven by a carriage motor 25.

A hardware configuration of the image forming apparatus 1 will be described.

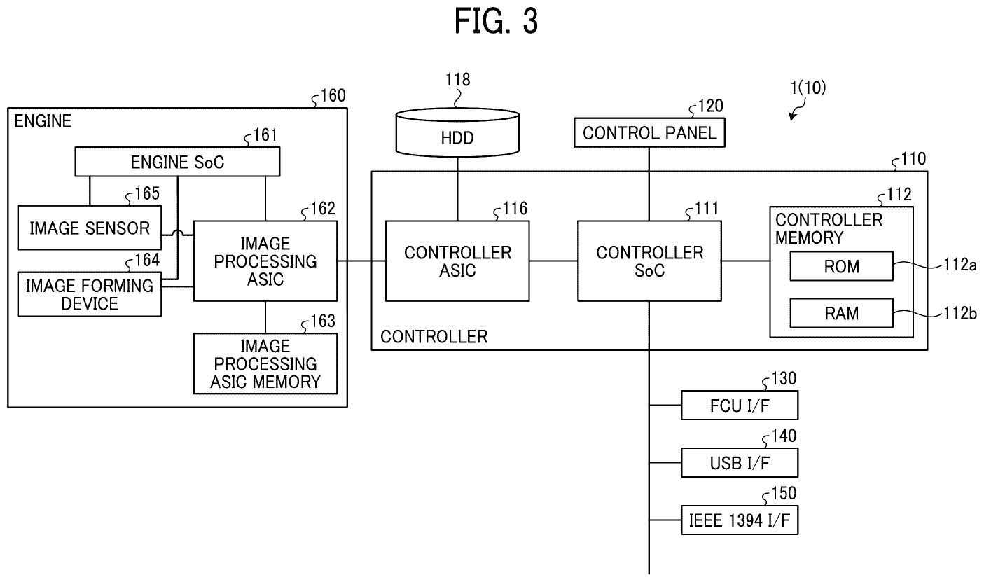

FIG. 3 is a block diagram illustrating a hardware configuration of the image forming apparatus 1. As illustrated in FIG. 3, in this configuration of the image forming apparatus 1, a controller 110 and an engine 160 are connected to each other by a peripheral component interface (PCI) bus. The controller 110 is a controller that controls the entire image forming apparatus 1 and controls rendering, communication, and input from an operation device (e.g., a control panel 120) of the image forming apparatus 1. The engine 160 is a printer engine connectable to the PCI bus, such as a monochrome plotter, a single-drum color plotter, a 4-drum color plotter, a scanner, or a FAX unit, for example. In addition to an engine part such as a plotter, the engine 160 further includes an image processing device that performs image processing such as error diffusion and gamma conversion.

The controller 110 includes a controller system-on-a-chip (SoC) 111, a controller memory (MEM-P) 112, and a controller application specific integrated circuit (ASIC) 116. The controller SoC 111 and the controller ASIC 116 are connected to each other by a bus.

The controller SoC 111 performs overall control of the image forming apparatus 1. The controller SoC 111 includes a central processing unit (CPU), and is connected to another device.

The controller memory 112 is a controller memory used as a memory for storing programs and data, a memory for deploying programs and data, or a rendering memory of a printer, for example. The controller memory 112 includes a read only memory (ROM) 112a and a random access memory (RAM) 112b. The ROM 112a is a read only memory used as a memory for storing programs and data. The RAM 112b is a writable and readable memory used as a memory for deploying programs and data or a rendering memory of a printer, for example.

The controller ASIC 116, which is an integrated circuit (IC) for image processing, includes hardware components for image processing. The controller ASIC 116 functions as a bridge that connects various busses and a hard disk drive (HDD) 118 to each other. The controller ASIC 116 includes a PCI target, an accelerated graphics port (AGP) master, an arbiter (ARB) as a major component of the controller ASIC 116, a memory controller that controls the HDD 118, a plurality of direct memory access controllers (DMACs) that perform processes such as the rotation of image data with a hardware logic, and a PCI unit that transmits data to and from the engine 160 via the PCI bus.

The HDD 118 is a storage device that stores image data, programs, font data, and forms.

The controller SoC 111 is connected to a facsimile control unit (FCU) interface (I/F) 130, a universal serial bus (USB) I/F 140, and an institute of electrical and electronics engineers (IEEE) 1394 I/F 150 via the PCI bus. The controller SoC 111 is directly connected to the control panel 120.

The engine 160 includes an engine SoC 161, an image processing ASIC 162, an image processing ASIC memory 163, an image forming device 164 (e.g., a plotter), and an image sensor 165. The image sensor 165 includes the CIS 15a and the CCD 24.

The engine SoC 161 controls the image forming device 164, the image sensor 165, and the image processing ASIC 162.

The engine SoC 161 and the controller SoC 111 communicate and cooperate with each other via the controller ASIC 116 and the image processing ASIC 162 to implement the overall operation of the image forming apparatus 1, including a particular operation set on the control panel 120 by a user.

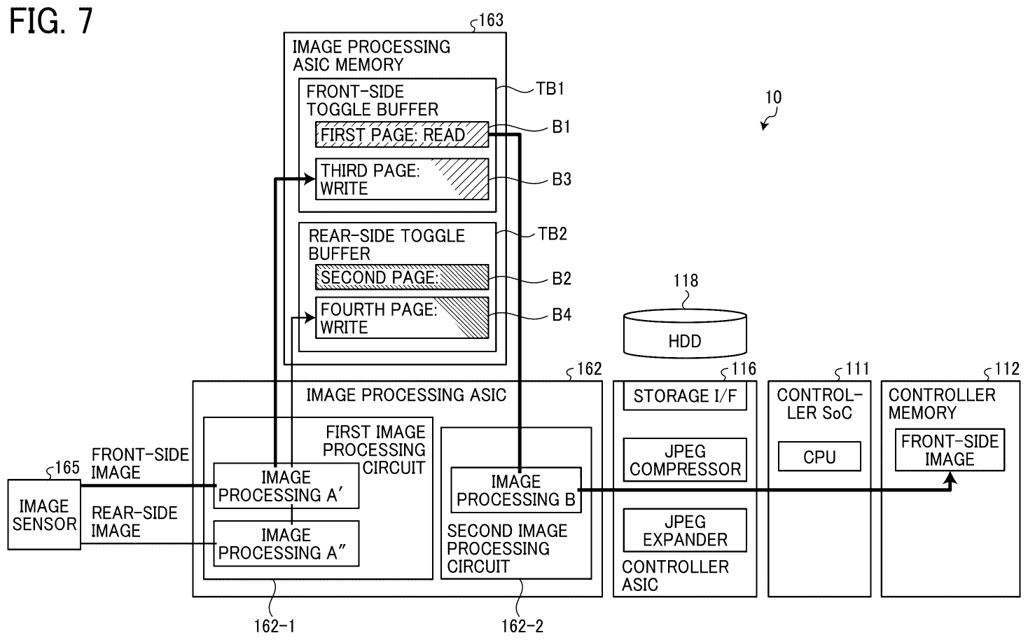

The image processing ASIC 162 includes a first image processing circuit 162-1 and a second image processing circuit 162-2, as illustrated in FIG. 7. The first image processing circuit 162-1 performs first image processing on a read image input from the image sensor 165. The second image processing circuit 162-2 performs second image processing on the read image.

More specifically, the first image processing circuit 162-1 is a feature value extraction unit that extracts a feature value from the entirety of the image stored in the image processing ASIC memory 163 or the image input from the image sensor 165 but yet to be written to the image processing ASIC memory 163. The second image processing circuit 162-2 is a feature value reflection unit that reflects the feature value extracted by the first image processing circuit 162-1 in the processing of the second image processing circuit 162-2.

The image processing ASIC memory 163 is used in the processing of the image processing ASIC 162. More specifically, the image processing ASIC memory 163 is a toggle buffer including a front-side toggle buffer TB1 and a rear-side toggle buffer TB2. The image processing ASIC memory 163 is an image storage unit that stores the read images of a plurality of pages subjected to the first image processing by the first image processing circuit 162-1 such that the front-side toggle buffer TB1 and the rear-side toggle buffer TB2 alternately store the read images.

The image processing ASIC 162 also functions as a control unit capable of performing in parallel the writing to the image processing ASIC memory 163 and the reading from the image processing ASIC memory 163. In the writing, the read images subjected to the first image processing by the first image processing circuit 162-1 are written to the image processing ASIC memory 163. In the reading, the read images stored in the image processing ASIC memory 163 are read to be subjected to the second image processing by the second image processing circuit 162-2.

With the above-described configuration, the read images read by the image sensor 165 are input to the image processing ASIC 162. In FIG. 3, the image reading device 10 is a unit having a function to read an image, and includes the image sensor 165, as described below.

As described above, in the reading process, the image reading device 10 reads the images of the document G while transporting the document G at a fixed velocity (i.e., constant velocity).

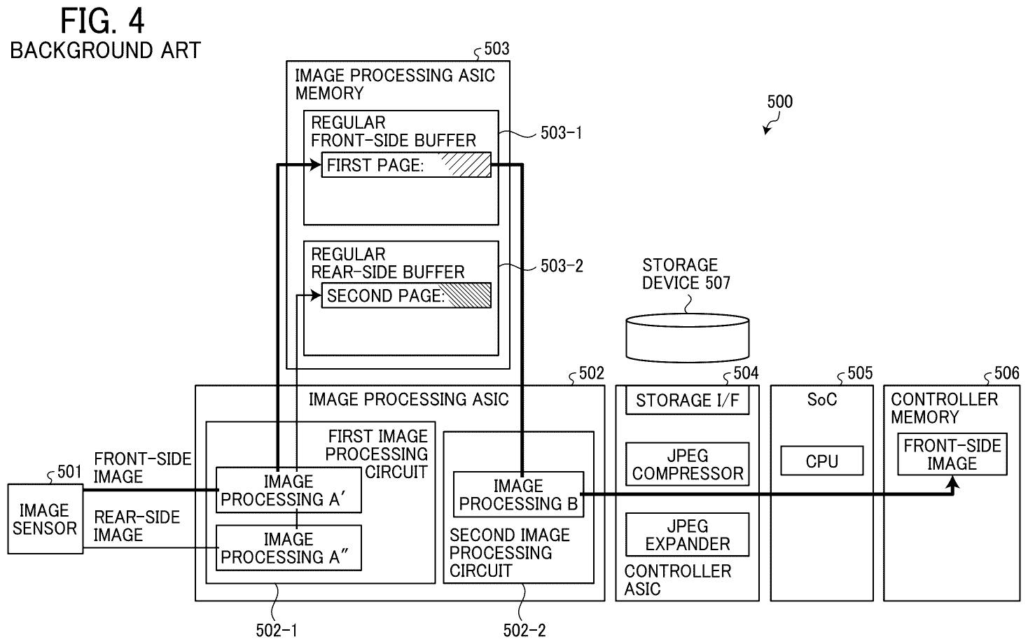

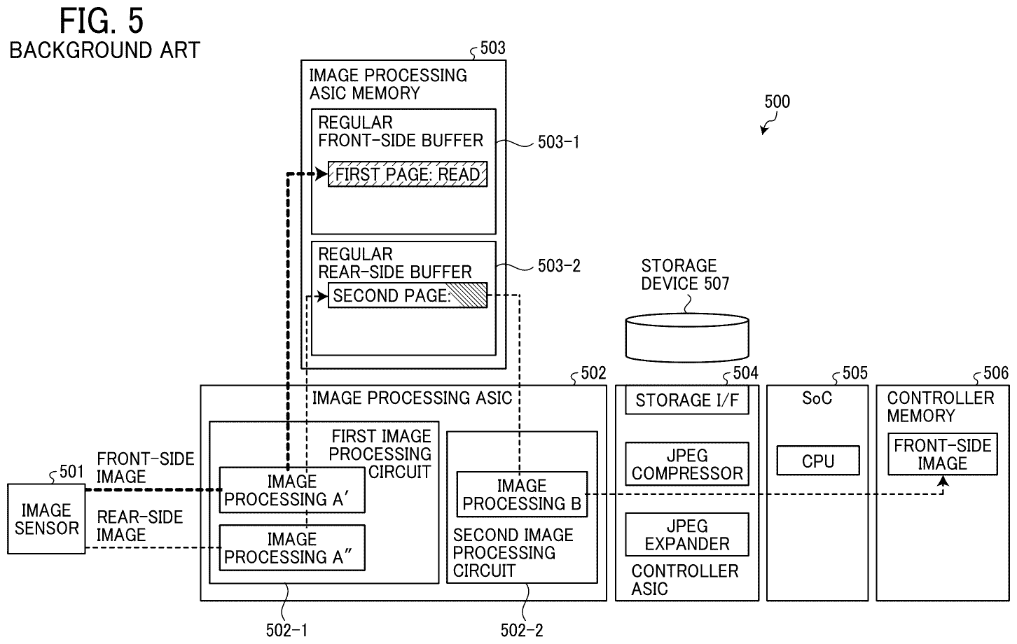

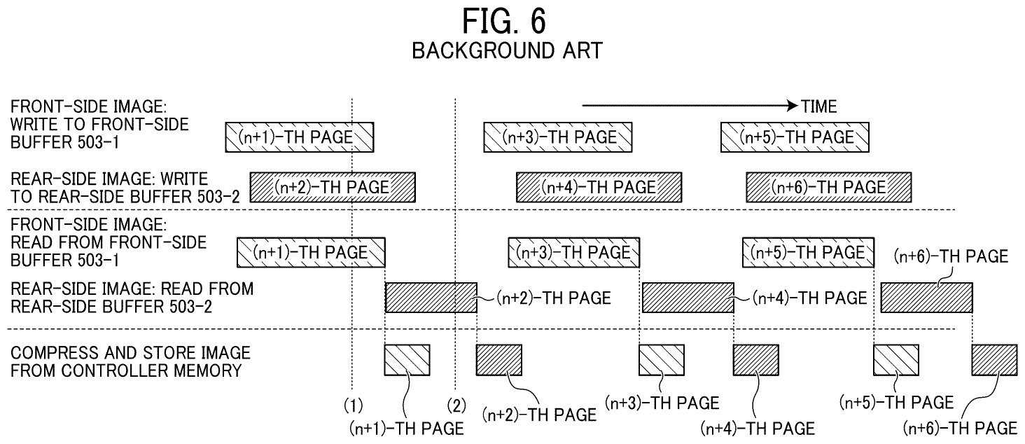

In the reading process during continuous document feeding, the document transport speed is determined by factors such as the sheet transport performance of the mechanism of the image reading device 10, the performance of sensors such as the CIS 15a and the CCD 24 forming the image sensor 165, the light source 21a, and the reading resolution. Therefore, increasing the document transport speed in the reading process to thereby improve the productivity of the reading process may involve improvement in the performance of the mechanism of the image reading device 10 and the performance of the sensors and an increase in the luminance of the light source 21a, for example, which increase manufacturing costs. FIG. 4 is a diagram illustrating an example of an operational overview of a background-art image reading device in a reading process. FIG. 5 is a diagram illustrating another example of the operational overview of the background-art image reading device in the reading process. FIG. 6 is a timing chart illustrating an operation of the background-art image reading device in the reading process.

FIG. 4 illustrates a reading operation in a background-art image reading device 500, which is configured to read the front and rear sides of a document in a single path, at a time (1) in FIG. 6. An image sensor 501 reads a document to create image data of the front side and the rear side of the document, and inputs the created image data to an image processing ASIC 502. The image processing ASIC 502 includes a first image processing circuit 502-1 and a second image processing circuit 502-2. The first image processing circuit 502-1 performs image processing A′ on the image data of the front side, and writes the image data of the front side to a regular front-side buffer 503-1 of an image proccing ASIC memory 503. The regular front-side buffer 503-1 has a capacity of storing the image data of one page. The first image processing circuit 502-1 similarly performs image processing A″ on the image data of the rear side, and writes the image data of the rear side to a regular rear-side buffer 503-2 of the image proccing ASIC memory 503. The regular rear-side buffer 503-2 has a capacity of storing the image data of one page. The background-art image reading device 500 simultaneously performs a writing operation and a reading operation. Then, in the background-art image reading device 500, the second image processing circuit 502-2 reads the image data stored in the regular front-side buffer 503-1, performs image processing B on the image data, and writes the image data to a controller memory 506 via a controller ASIC 504 and an SoC 505.

FIG. 5 illustrates a reading operation in the background-art image reading device 500, which is configured to read the front and rear sides of a document in a single path, at a time (2) in FIG. 6. At the time (2), the image sensor 501 of the background-art image reading device 500 is in an interval between the reading of a document and the reading of the next document; no image is input to the image sensor 501. In the background-art image reading device 500, the image of the second page has already been entirely written to the regular rear-side buffer 503-2 at the time (2). The second image processing circuit 502-2 reads the stored image data, performs the image processing B on the image data, and writes the image data to the controller memory 506 via the controller ASIC 504 and the SoC 505.

FIG. 6 is a timing chart of a single-path two-side image reading operation in the background-art image reading device 500. As described above, the time (1) represents the time at which the operation of FIG. 4 takes place, and the time (2) represents the time at which the operation of FIG. 5 takes place. In the background-art image reading device 500, the image sensor 501 starts the reading operation, and the image data of the front side and the image data of the rear side start to be written to the regular front-side buffer 503-1 and the regular rear-side buffer 503-2, respectively. Then, the second image processing circuit 502-2 starts reading the front-side image from the regular front-side buffer 503-1, performs the image processing B on the front-side image, and writes the front-side image to the controller memory 506. In the background-art image reading device 500, after reading the front-side image from the regular front-side buffer 503-1 and performing the image processing B on the front-side image, the second image processing circuit 502-2 starts reading the rear-side image from the regular rear-side buffer 503-2, performs the image processing B on the rear-side image, and writes the rear-side image to the controller memory 506.

In the background-art image reading device 500, each of the front-side image and the rear-side image written to the controller memory 506 is input to a joint photographic experts group (JPEG) compressor module of the controller ASIC 504 in FIGS. 4 and 5 to generate JPEG-encoded data, which is then written to a storage device 507 via a storage interface (I/F). In the background-art image reading device 500, this process is alternately performed on the front-side image and the rear-side image.

As illustrated in FIG. 6, reading the image of one page from the regular front-side buffer 503-1 takes more time than reading the image of one page from the regular rear-side buffer 503-2. This is because the operation of reading from the regular front-side buffer 503-1 starts before the front-side reading operation completes. That is, the reading from the regular front-side buffer 503-1 is slowed down to adjust to the speed of the reading process of the image sensor 501, although the throughput of the image processing B is higher than that of the reading process of the image sensor 501. Meanwhile, the rear-side reading operation of the image sensor 501 completes during the operation of reading from the regular rear-side buffer 503-2, making the reading from the regular rear-side buffer 503-2 unlimited by the processing speed of the image sensor 501. Consequently, the processing time of the reading from the regular rear-side buffer 503-2 is less than that of the reading from the regular front-side buffer 503-1.

As described above, in the background-art image reading device 500, the speed of buffer reading and subsequent processing is limited by the processing speed of the image sensor 501, reducing productivity.

In the background-art image reading device 500, there is a period in which the document reading is not taking place, with no data being written to the regular front-side buffer 503-1 or the regular rear-side buffer 503-2 (hereinafter referred to as the interval between documents). In the background-art image reading device 500, the interval between documents is understood as the time obtained by subtracting the time of reading the front-side image from the processing time of the image processing B on the front-side image, the processing time of the image processing B on the rear-side image, and the time taken for communication and the setting of the image processing ASIC 502. Therefore, reducing the processing time of the image processing B on the front-side image or the rear-side image shortens the interval between documents, thereby improving productivity. The improvement in productivity by this method is limited by the processing speed of the reading process, as compared with a method of improving productivity by increasing the document transport speed in the reading process. The method, however, suppresses an increase in cost, as described in detail bellow.

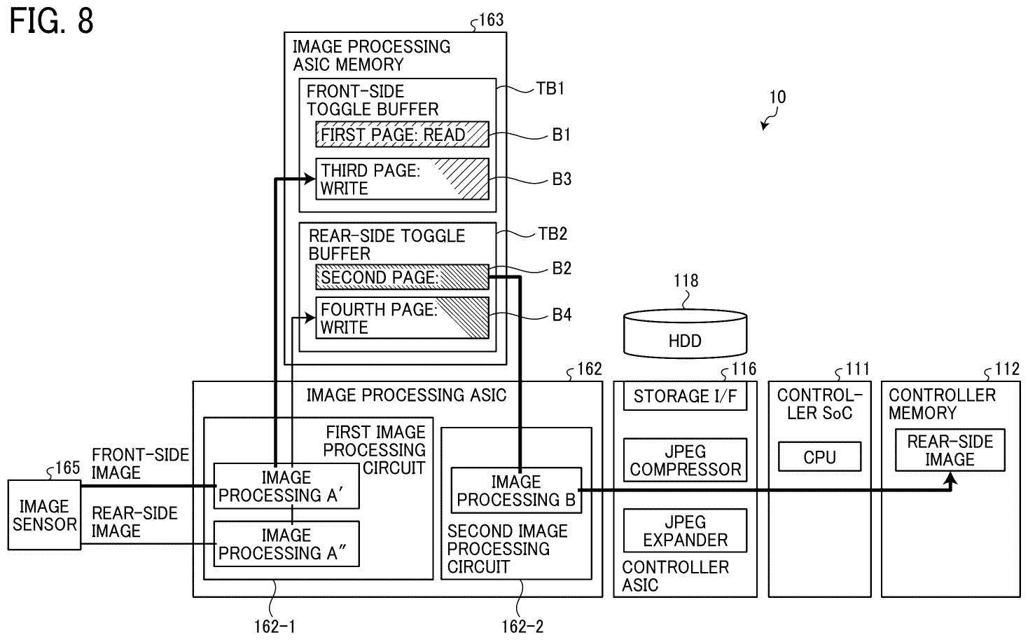

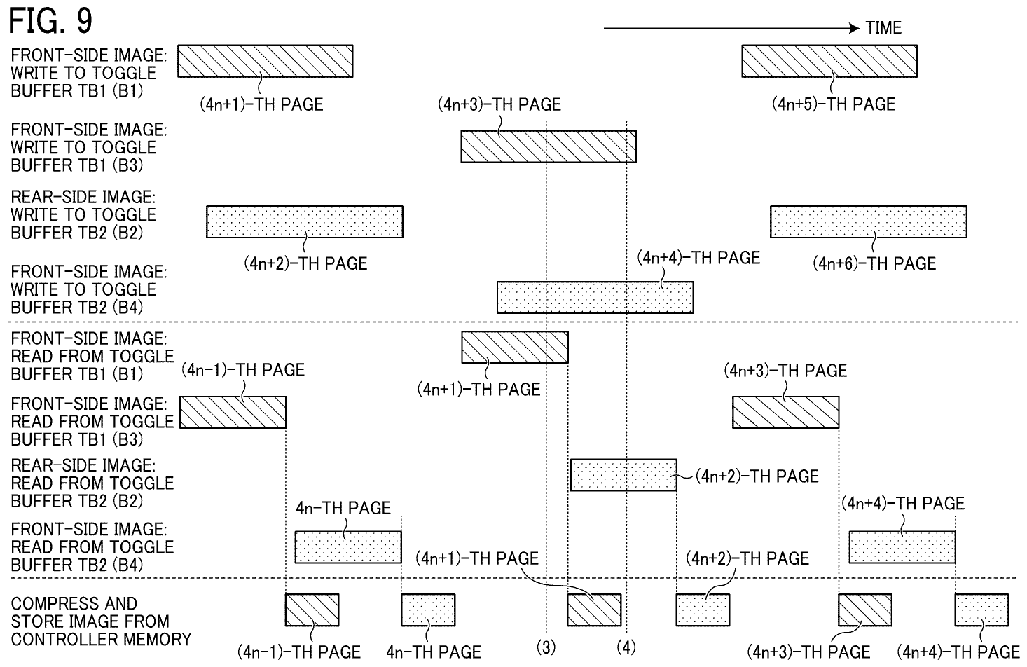

FIG. 7 is a diagram illustrating an example of an operational overview of the image reading device 10 according to the first embodiment in a reading process. FIG. 8 is a diagram illustrating another example of the operational overview of the image reading device 10 according to the first embodiment in the reading process. FIG. 9 is a timing chart illustrating an operation of the image reading device 10 according to the first embodiment in the reading process.

FIGS. 7, 8, and 9 illustrate an exemplary operational overview, another exemplary operational overview, and a timing chart, respectively, of the single-path two-side image reading operation of the image reading device 10 according to the first embodiment using toggle buffers. In the timing chart of FIG. 9, a time (3) represents the time at which the operation of FIG. 7 takes place, and a time (4) represents the time at which the operation of FIG. 8 takes place.

FIG. 7 illustrates the single-path two-side image reading operation of the image reading device 10 at the time (3) in the timing chart of FIG. 9. The background-art image reading device 500 performs the image processing A′ and the image processing A″ on the front-side image and the rear-side image, respectively, and stores the front-side image and the rear-side image in the regular front-side buffer 503-1 and the regular rear-side buffer 503-2, respectively. The image processing ASIC 162 of the first embodiment, on the other hand, performs the image processing A′ and the image processing A″ on the front-side image and the rear-side image, respectively, and stores the front-side image and the rear-side image in a buffer B3 of a front-side toggle buffer TB1 and a buffer B4 of a rear-side toggle buffer TB2, respectively. Each of the front-side toggle buffer TB1 and the rear-side toggle buffer TB2 has a capacity of storing the image data of two pages corresponding to the front or rear side.

Simultaneously with the above-described operation, the image processing ASIC 162 reads, from a buffer B1 of the front-side toggle buffer TB1, the image data of the front side of a document read immediately before the currently read document and stored in the buffer B1, and performs the image processing B on the image data of the front side of the document. The image processing ASIC 162 then writes the image data of the front side of the document to the controller memory 112 via the controller ASIC 116 and the controller SoC 111.

The image reading device 10 of the first embodiment includes the thus-configured front-side toggle buffer TB1, in which the image from the image sensor 165 is written to one buffer and the stored image is read from the other buffer.

FIG. 8 illustrates the single-path two-side image reading operation of the image reading device 10 at the time (4) in the timing chart of FIG. 9. The background-art image reading device 500 performs the image processing A′ and the image processing A″ on the front-side image and the rear-side image, respectively, and stores the front-side image and the rear-side image in the regular front-side buffer 503-1 and the regular rear-side buffer 503-2, respectively. The image processing ASIC 162 of the first embodiment, on the other hand, performs the image processing A′ and the image processing A″ on the front-side image and the rear-side image, respectively, and stores the front-side image and the rear-side image in the buffer B3 of the front-side toggle buffer TB1 and the buffer B4 of the rear-side toggle buffer TB2, respectively.

Simultaneously with the above-described operation, the image processing ASIC 162 reads, from a buffer B2 of the rear-side toggle buffer TB2, the image data of the rear side of a document read immediately before the currently read document and stored in the buffer B2, and performs the image processing B on the image data of the rear side of the document. The image processing ASIC 162 then writes the image data of the rear side of the document to the controller memory 112 via the controller ASIC 116 and the controller SoC 111.

The image reading device 10 of the first embodiment includes the thus-configured rear-side toggle buffer TB2, in which the image from the image sensor 165 is written to one buffer and the stored image is read from the other buffer.

As described above, in the first embodiment, front-side images are stored in the buffers B1 and B3, and rear-side images are stored in the buffers B2 and B4. In the case of the front-side images, the reading from the buffer B3 takes place during the writing to the buffer B1, and the reading from the buffer B1 takes place during the writing to the buffer B3. In the case of the rear-side images, the reading from the buffer B4 takes place during the writing to the buffer B2, and the reading from the buffer B2 takes place during the writing to the buffer B4. In buffer writing, the image of a read document is written to a buffer different from a buffer used to write the image of a previous document.

With the above-described configuration, the image reading device 10 of the first embodiment improves in productivity as compared with the background-art image reading device 500 with the single buffers, in which the speed of buffer reading and subsequent processing is limited by the processing speed of the image sensor 501, reducing productivity. Consequently, the image reading device 10 of the first embodiment speeds up the process of reading the image data of one document (i.e., the front side and the rear side of one document) from the toggle buffers during the time of reading the image data of one document from the image sensor 165 (approximately equal to the time of writing the image data of the document to the toggle buffers).

As described above, when storing in buffers the images of two sides of documents input from the image sensor 165 and subjected to the image processing, the first embodiment uses, in toggling fashion, the front-side toggle buffer TB1 and the rear-side toggle buffer TB2 each capable of storing the image data of two pages corresponding to the front or rear side. That is, the image data of one page input from the image sensor 165 is written to one buffer, and the stored image of another page is read from another buffer. Thereby, the speed of reading the stored image is not limited by the processing speed of the image sensor 165. Consequently, the processing speed is increased, avoiding a decline in productivity.

A second embodiment of the present invention will be described.

The following description of the second embodiment will focus on differences from the first embodiment, and description of similarities thereto will be omitted.

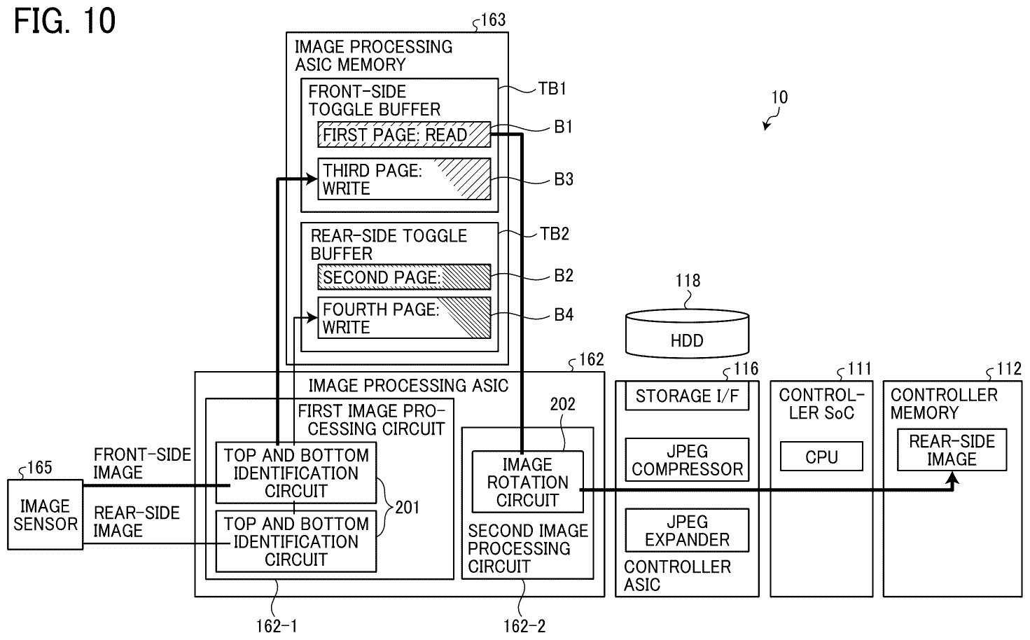

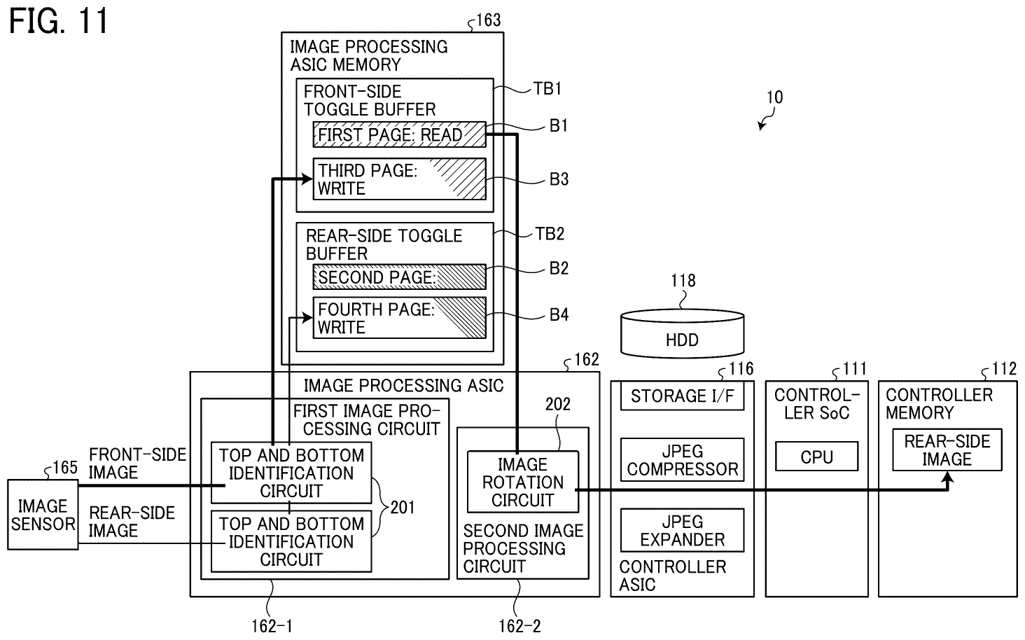

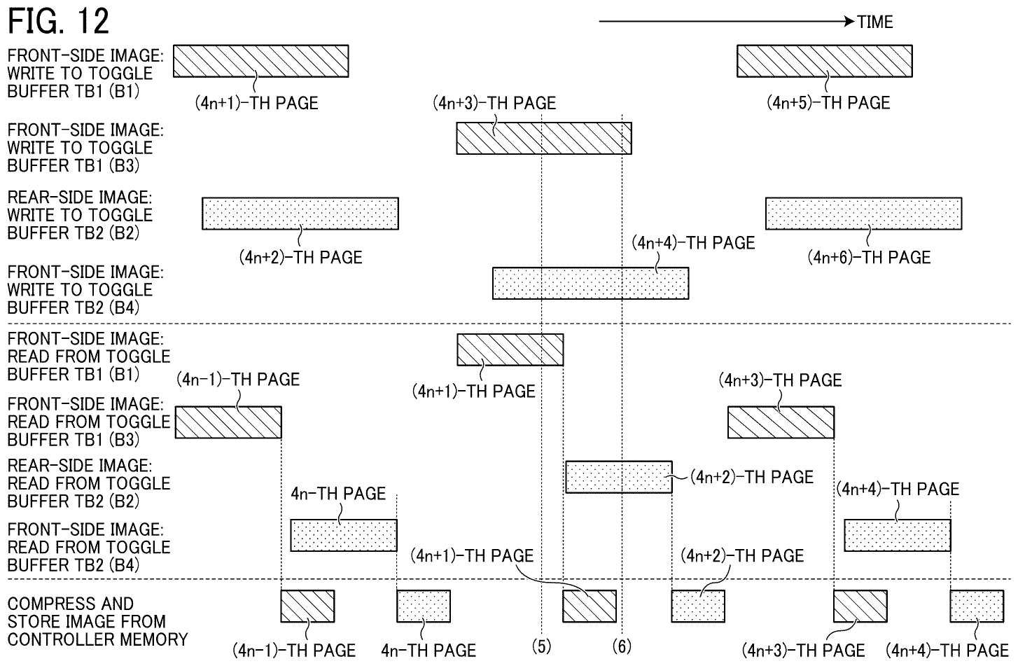

FIG. 10 is a diagram illustrating an example of the operational overview of the image reading device 10 according to the second embodiment in the reading process. FIG. 11 is a diagram illustrating another example of the operational overview of the image reading device 10 according to the second embodiment in the reading process. FIG. 12 is a timing chart illustrating an operation of the image reading device 10 according to the second embodiment in the reading process.

FIGS. 10, 11, and 12 illustrate an operational overview of a front-side reading process, an operational overview of a rear-side reading process, and a timing chart, respectively, of the single-path two-side image reading operation by the image reading device 10 of the second embodiment. In the second embodiment, the first image processing circuit 162-1 identifies the top and bottom of each image with toggle buffers, and an image rotation circuit 202 of the second image processing circuit 162-2 rotates the image based on a top and bottom identification result (i.e., top and bottom identification information as the feature value). In the timing chart of FIG. 12, a time (5) represents the time at which the operation of FIG. 10 takes place, and a time (6) represents the time at which the operation of FIG. 11 takes place.

In the above-described first embodiment, the image path of the image reading device 10 in the single-path two-side image reading operation uses the toggle buffers in place of the single buffers of the background-art image reading device 500 to improve productivity. Using the toggle buffers in the image path of the image reading device 10 in the single-path two-side image reading operation provides other effects, as described below.

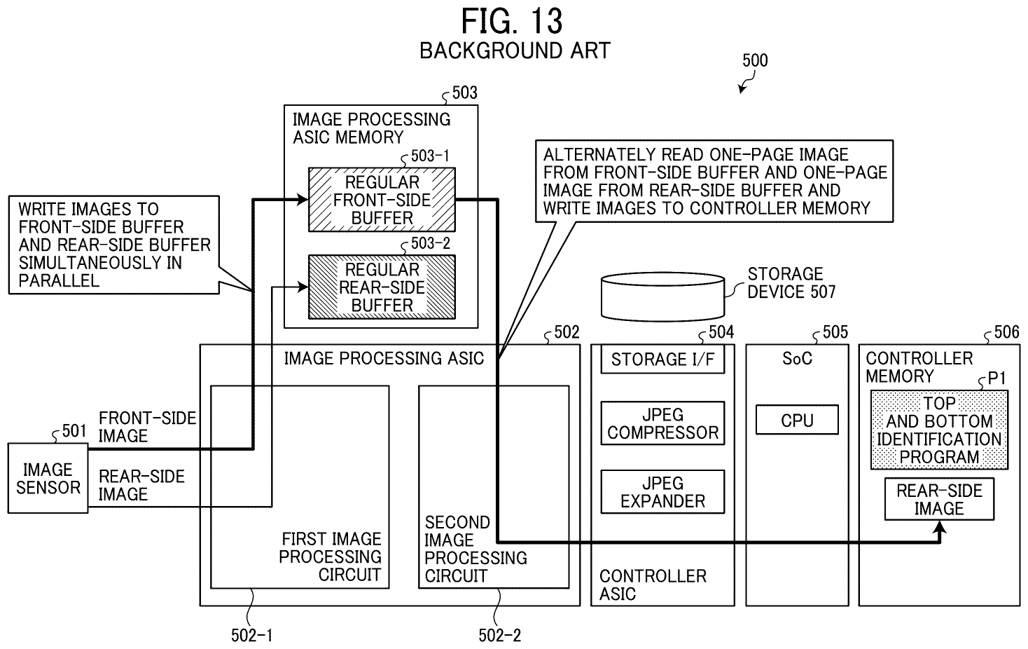

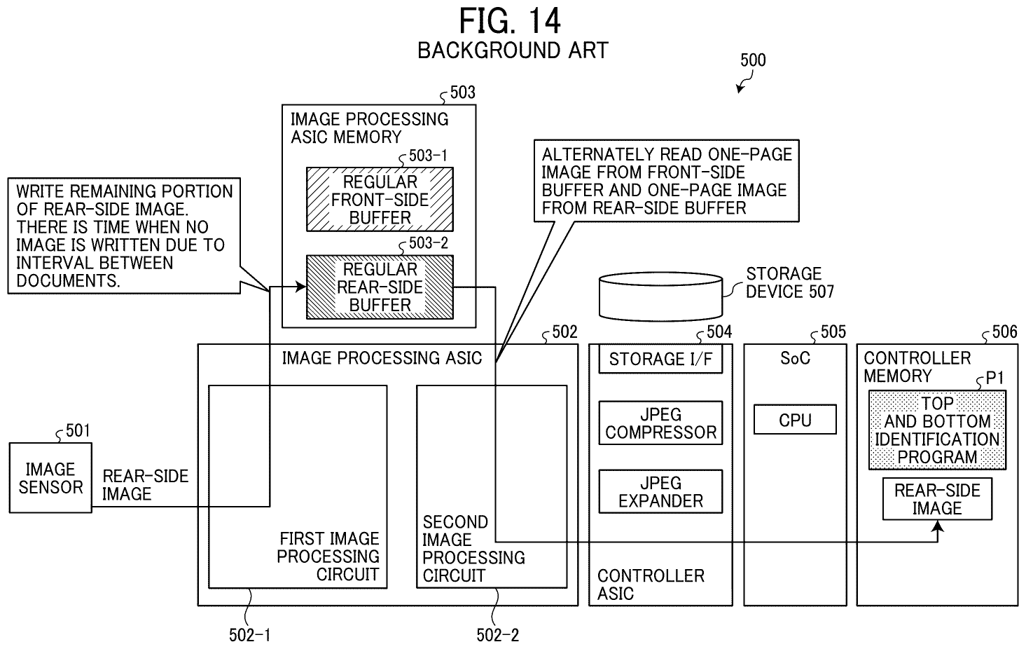

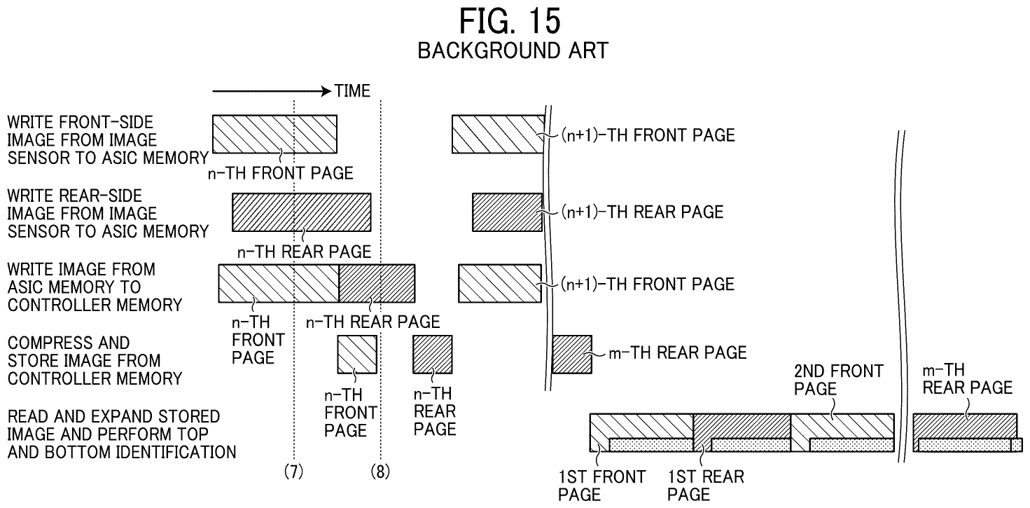

FIG. 13 is a diagram illustrating an example of the operational overview of the background-art image reading device 500 in the front-side reading process. FIG. 14 is a diagram illustrating another example of the operational overview of the background-art image reading device 500 in the rear-side reading process. FIG. 15 is a timing chart illustrating an operation of the background-art image reading device 500 in the reading process.

As illustrated in FIGS. 13 and 14, in the image reading from the image sensor 501 of the background-art image reading device 500, the image of each or one side of a document is input to the image processing ASIC 502 connected to the reading unit 510, and the first image processing circuit 502-1 performs image processing on the input image. In the background-art image reading device 500, the image processing ASIC 502 reads the images stored in the image processing ASIC memory 503, performs image processing on the read images with the second image processing circuit 502-2, and transmits the processed images to the controller ASIC 504. In this process, the image processing of the second image processing circuit 502-2 is performed on the image of one side of the document at a time. In the timing chart of FIG. 15, the time (7) represents the time at which the operation of FIG. 13 takes place, and the time (8) represents the time at which the operation of FIG. 14 takes place.

In the background-art image reading device 500, each of the regular front-side buffer 503-1 and the regular rear-side buffer 503-2 has a capacity of storing the image data of one page corresponding to the input image of one side of the document. In the front-side reading (also occasionally in the rear-side reading) of the single-path two-side image reading operation, data items of one page sequentially written from the image sensor 501 to the regular front-side buffer 503-1 from the head of the regular front-side buffer 503-1 are sequentially read into the controller ASIC 504 from the head of the regular front-side buffer 503-1 before all of the data items are written to the regular front-side buffer 503-1. At the beginning of the reading from the regular front-side buffer 503-1, therefore, the feature value derived from the entire image is not determined yet and thus is not reflected in the parameters of the image processing of the second image processing circuit 502-2. If the reading from the regular front-side buffer 503-1 is performed after the feature value is determined, buffer reading and buffer writing alternate. That is, after the entire image data of one page is written to the regular front-side buffer 503-1 from the image sensor 501, the entire image data of the page is read from the regular front-side buffer 503-1, which substantially reduces productivity.

Further, a CPU of the SoC 505 for performing the processing of a controller executes a program to perform a process of transferring the image placed in the controller memory 506 to the JPEG compressor module of the controller ASIC 504 to convert the image into a JPEG image, and storing the JPEG image in the storage device 507 from the controller ASIC 504 via the storage I/F.

The CPU of the SoC 505 for performing the processing of the controller further executes a top and bottom identification program P1 to perform top and bottom identification based on the image, reflects the top and bottom identification result in a portable document format (PDF) image, and transmits the PDF image. According to the program, after the process of reading a sequence of images from the image sensor 501, writing each of the images to the controller memory 506, and compressing and storing the image in the storage device 507, the image stored in the storage device 507 is read via the storage I/F and expanded in the controller memory 506 by the JPEG expander. Then, the top and bottom identification is performed based on the image expanded by the top and bottom identification program P1. In the background-art image reading device 500, the top and bottom identification result is used as a PDF element and packed together with the original JPEG image to generate the PDF image, which is transmitted in accordance with the intended use.

If the configuration of the program is changed to output the image with orientation information stored in exchangeable image file format (Exif) instead of the PDF image, the image per se is not rotated. In this case, the image may be displayed without consideration of the orientation information stored in Exif, i.e., the image may fail to be displayed in the correct orientation, depending on the viewer.

The second embodiment, therefore, uses the toggle buffers in place of the single buffers used in the background-art image reading device 500 configured to read the front and rear sides of a document in a single path. Further, the first image processing circuit 162-1 includes top and bottom identification circuits 201 as top and bottom identification units, and the second image processing circuit 162-2 includes the image rotation circuit 202 as an image rotation unit, as illustrated in FIGS. 10 and 11. The toggle buffers of the second embodiment are similar to those described above in the first embodiment.

Each of the top and bottom identification circuits 201 identifies the orientation of the image based on the input image of one page corresponding to the front or rear side of the document. The image rotation circuit 202 writes the input image to the controller memory 112 such that the written image is rotated.

In the second embodiment using the toggle buffers, the entire image of a certain page is first subjected to the processing of the first image processing circuit 162-1 and then to the processing of the second image processing circuit 162-2, and the processed image is transmitted to the controller ASIC 116. Therefore, the feature value determined based on the entire image is extracted by the first image processing circuit 162-1 and transmitted to the second image processing circuit 162-2 to reflect the feature value in the processing result of the second image processing circuit 162-2, without compromising productivity.

In the second embodiment, after the image is input to the first image processing circuit 162-1, the image processing ASIC 162 reflects the top and bottom identification result in a rotation orientation parameter to be transmitted to the image rotation circuit 202 of the second image processing circuit 162-2.

With the above-described processing of the second embodiment, the JPEG image is stored as rotated in the intended image orientation. When outputting the JPEG image, therefore, it is unnecessary to specify the orientation of the image with the orientation information in the Exif, enabling the image to be displayed in the correct orientation regardless of the viewer.

Further, the image reading device 10 of the second embodiment obviates the need for the process of reading the image from the storage device, expanding the image, and identifying the top and bottom of the image, while this process is performed in the background-art image reading device 500 to execute the top and bottom identification process with the CPU of the SoC 505 to output the PDF image with the top and bottom identification program P1. Consequently, the image reading device 10 of the second embodiment implements high-speed processing.

As describe above, the image reading device 10 of the second embodiment improves in productivity as compared with the background-art image reading device 500 not using toggle buffers. Further, the image reading device 10 of the second embodiment rotates the image per se, unlike detecting the top and bottom of the image after the output of the image to the controller memory and embedding the detected top and bottom in the image as tag information. Consequently, the image is displayed in the correct orientation regardless of viewer software, and productivity is improved.

A third embodiment of the present invention will be described.

The third embodiment is different from the second embodiment in using a top and bottom identification program P2 executed by a built-in CPU built in the image processing ASIC 162. The following description of the third embodiment will focus on differences from the first and second embodiments, and description of similarities thereto will be omitted.

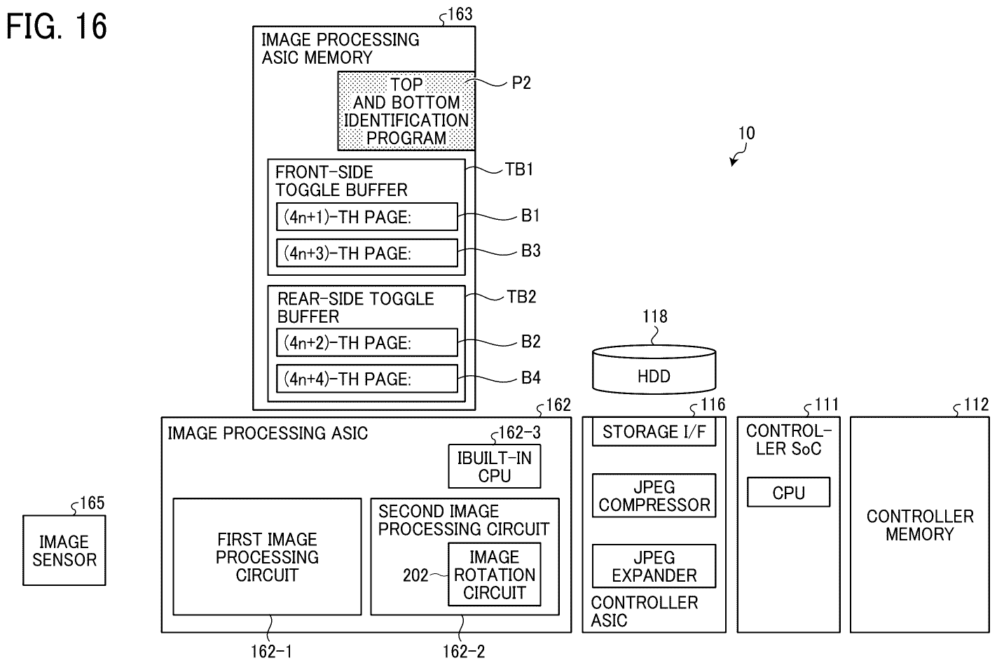

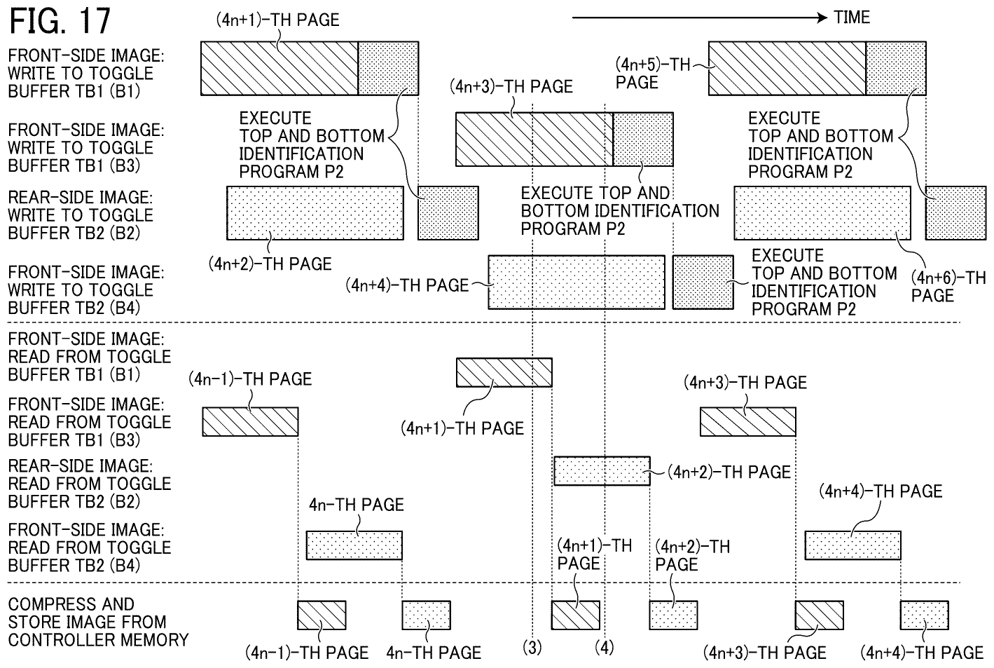

FIG. 16 is a diagram illustrating an example of the operational overview of the image reading device 10 according to the third embodiment in the reading process. FIG. 17 is a time chart illustrating an operation of the image reading device 10 according to the third embodiment in the reading process.

In the example of FIGS. 16 and 17, the top and bottom identification circuits 201 described in the second embodiment are replaced by the top and bottom identification program P2 executed by a built-in CPU 162-3 built in the image processing ASIC 162.

As illustrated in the timing chart of FIG. 17, the image processing ASIC 162 writes the image of one page to the buffer B1 of the front-side toggle buffer TB1, and then executes the top and bottom identification program P2 to obtain the top and bottom identification result. When reading the image from the buffer B1 of the front-side toggle buffer TB1 and operating the image rotation circuit 202 in the second image processing circuit 162-2, the image processing ASIC 162 reflects the obtained top and bottom identification result in the processing of the image processing ASIC 162 as the rotation orientation parameter.

With the processing of the third embodiment, the JPEG image is stored as rotated in the intended image orientation similarly as in the second embodiment. When outputting the JPEG image, therefore, it is unnecessary to specify the orientation of the image with the orientation information in the Exif, enabling the image to be displayed in the correct orientation regardless of the viewer.

Further, the image reading device 10 of the third embodiment obviates the need for the process of reading the image from the storage device, expanding the image, and identifying the top and bottom of the image, while this process is performed in the background-art image reading device 500 to execute the top and bottom identification process with the CPU of the SoC 505 to output the PDF image with the top and bottom identification program P1. Consequently, the image reading device 10 of the third embodiment implements high-speed processing.

A fourth embodiment of the present invention will be described.

The fourth embodiment is different from the second embodiment in being configured to perform one-side reading. The following description of the fourth embodiment will focus on differences from the first and second embodiments, and description of similarities thereto will be omitted.

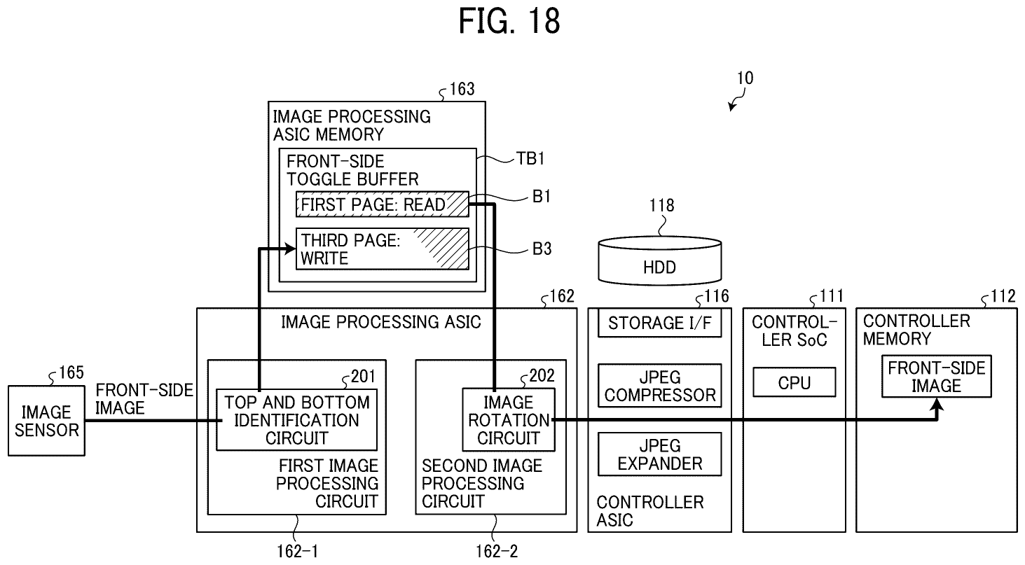

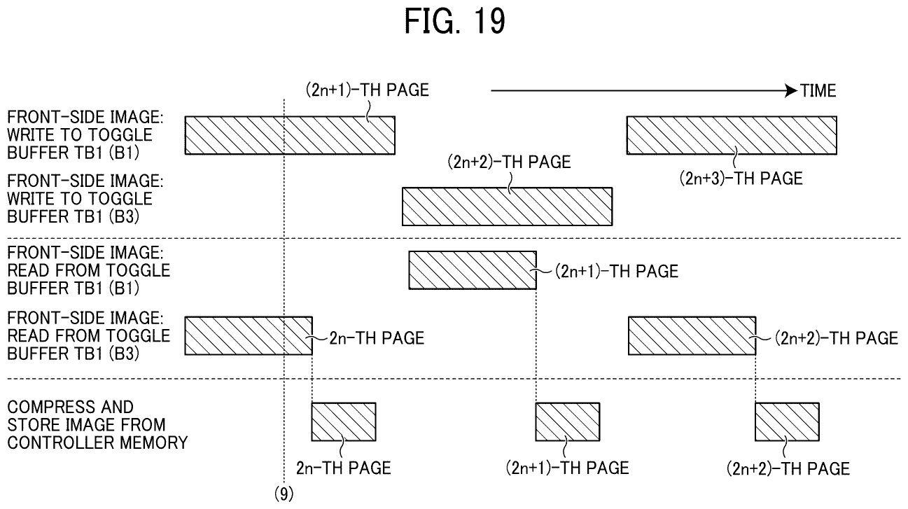

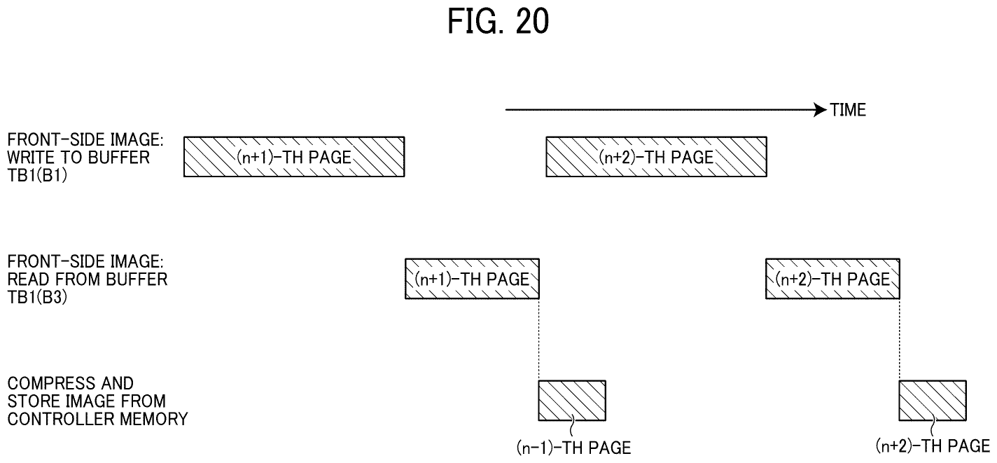

FIG. 18 is a diagram illustrating an example of the operational overview of the image reading device 10 according to the fourth embodiment in the reading process. FIG. 19 is a time chart illustrating an operation of the image reading device 10 according to the fourth embodiment in the reading process. FIG. 20 is a time chart illustrating an operation of a comparative example in which the front-side toggle buffer TB1 of the image reading device 10 of the fourth embodiment is replaced by a single buffer as in the background-art image reading 500. In the timing chart of FIG. 19, a time (9) represents the time at which the operation of FIG. 18 takes place.

FIGS. 18 and 19 illustrate a modification of the configuration of the image reading device 10 according to the second embodiment to perform the one-side reading. FIG. 20 is a timing chart illustrating an operation of a comparative example in which the front-side toggle buffer TB1 of the image reading device 10 of the fourth embodiment is replaced by a single buffer. As illustrated in FIG. 20, in the comparative example using the singular buffer in place of the front-side toggle buffer TB1, it is after the writing of the front-side image to the single buffer is completed and the top and bottom identification result is output from the top and bottom identification circuit 201 that the front-side image is read from the single buffer and the top and bottom identification result is reflected in the processing of the image rotation circuit 202 of the second image processing circuit 162-2. That is, the buffer writing and the buffer reading are performed alternately (not simultaneously), as illustrated in the timing chart of FIG. 20.

According to the image reading device 10 of the fourth embodiment, on the other hand, when the image processing ASIC 162 writes the data of the (2n+1)-th page to the buffer B1 of the front-side toggle buffer TB1, the top and bottom identification result of the 2n-th page has already been determined, as illustrated in FIG. 19. Therefore, the image processing ASIC 162 is able to simultaneously perform the reading from the buffer B1 of the front-side toggle buffer TB1 and the writing to the buffer B3 of the front-side toggle buffer TB1. Consequently, productivity is improved as compared with the configuration of the comparative example in FIG. 20, in which the buffer writing and the buffer reading are performed alternately (not simultaneously) as in the background-art image reading device 500.

A fifth embodiment of the present invention will be described.

The fifth embodiment is different from the third embodiment in being configured to perform the one-side reading. The following description of the fifth embodiment will focus on differences from the first to third embodiments, and description of similarities thereto will be omitted.

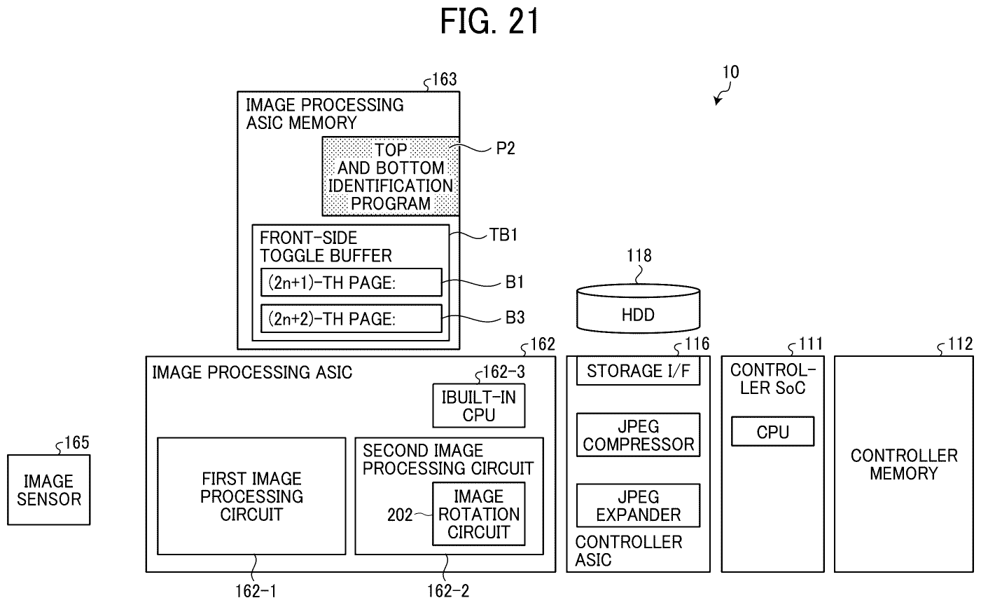

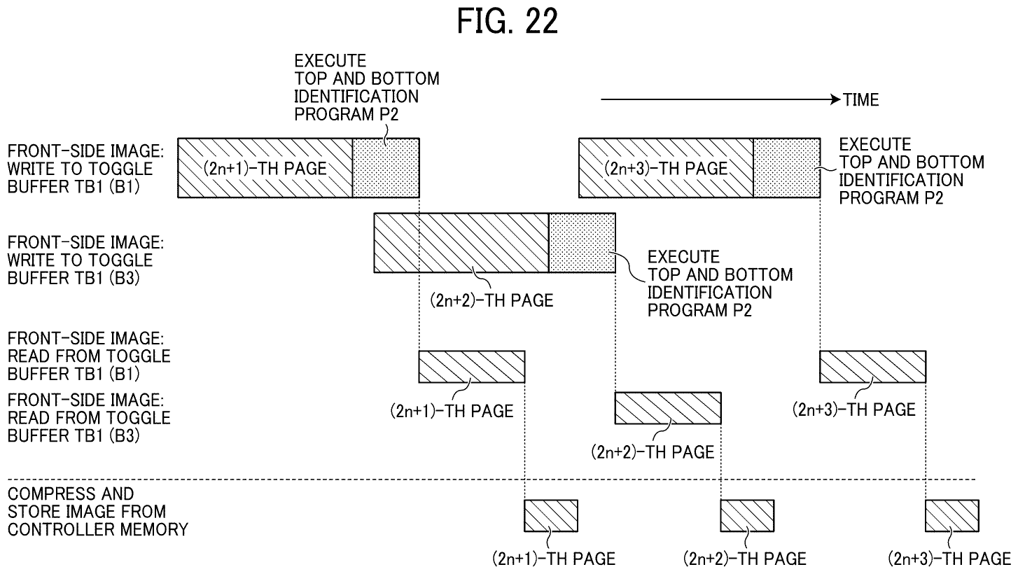

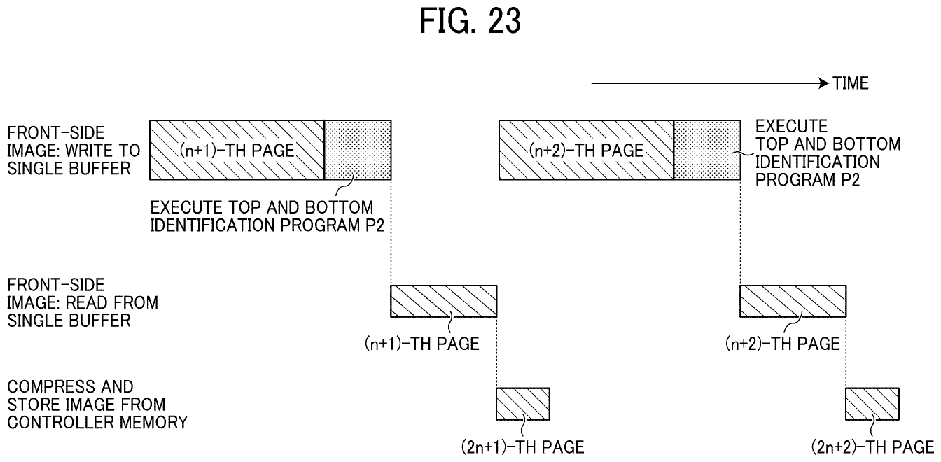

FIG. 21 is a diagram illustrating an example of the operational overview of the image reading device 10 according to the fifth embodiment in the reading process. FIG. 22 is a time chart illustrating an operation of the image reading device 10 according to the fifth embodiment in the reading process. FIG. 23 is a timing chart illustrating an operation of a comparative example in which the front-side toggle buffer TB1 of the image reading device 10 according to the fifth embodiment is replaced by a single buffer as in the background-art image reading device 500.

FIGS. 21 and 22 illustrate a modification of the configuration of the image reading device 10 according to the third embodiment to perform the one-side reading. FIG. 23 illustrates a timing chart of an operation of a comparative example in which the front-side toggle buffer TB1 of the image reading device 10 according to the fifth embodiment is replaced by a single buffer as in the background-art image reading device 500.

According to the fifth embodiment, productivity is improved as compared with the configuration of the comparative example in FIG. 23, in which the front-side toggle buffer TB1 is replaced by a single buffer.

A sixth embodiment of the present invention will be described.

The following description of the sixth embodiment will focus on differences from the first to third embodiments, and description of similarities thereto will be omitted.

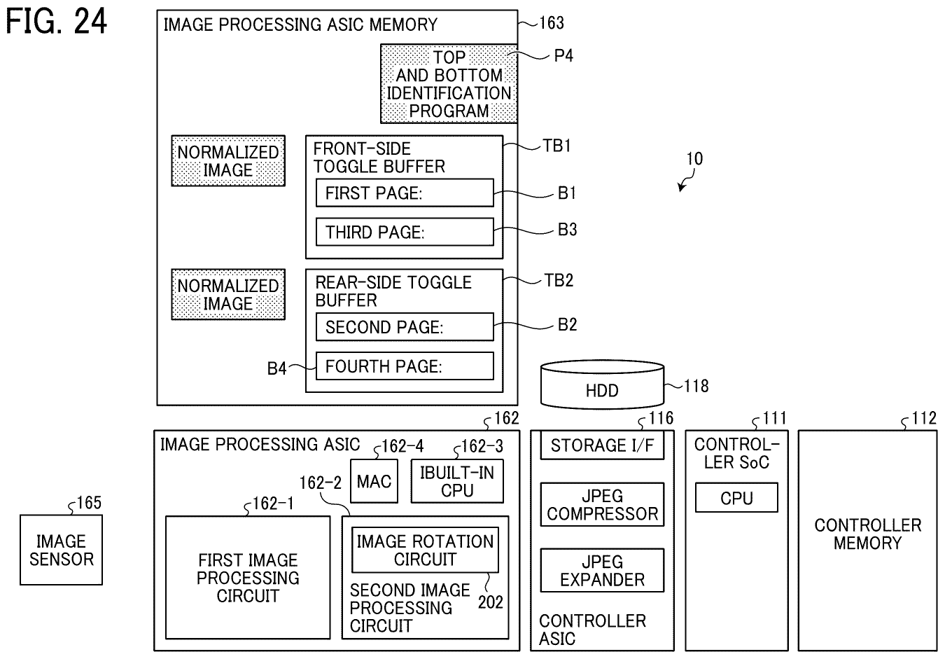

FIG. 24 is a diagram illustrating an example of the operational overview of the image reading device 10 according to the sixth embodiment in the reading process. FIG. 24 illustrates a configuration example of the sixth embodiment including a top and bottom identification program P4 in place of the top and bottom identification program P2 of the third embodiment, and using inference based on machine learning.

According to the top and bottom identification program P4, the image stored in the front-side toggle buffer TB1 or the rear-side toggle buffer TB2 of the image processing ASIC memory 163 is normalized with an inference model for top and bottom identification to generate a normalized image, and the normalized image is written to the image processing ASIC memory 163. Then, based on the normalized image, inference is made with a model that has learned for top and bottom identification, to thereby derive a top and bottom identification result. The model that has learned for top and bottom identification is included in the top and bottom identification program 4.

The image processing ASIC 162 reflects the top and bottom identification result derived with the top and bottom identification program P4 in the processing of the image rotation circuit 202 of the second image processing circuit 162-2, to thereby output the image in the correct orientation.

In the configuration illustrated in FIG. 24, to reduce the processing load on the built-in CPU 162-3 of the image processing ASIC 162 in the calculation of the inference, a multiply-and-accumulate unit (MAC) 162-4 is used from the built-in CPU 162-3 of the image processing ASIC 162.

The MAC 162-4 may be a circuit specialized in multiply-and-accumulate operation, or may be a general-purpose circuit, such as a graphics processing unit (GPU), that performs multiply-and-accumulate operation.

If an extension of processing time is allowed, the multiply-and-accumulate operation may be performed with the built-in CPU 162-3, not with the MAC 162-4. In this case, the cost of installing the MAC 162-4 in the hardware is saved.

A seventh embodiment of the present invention will be described.

The following description of the seventh embodiment will focus on differences from the first to sixth embodiments, and description of similarities thereto will be omitted.

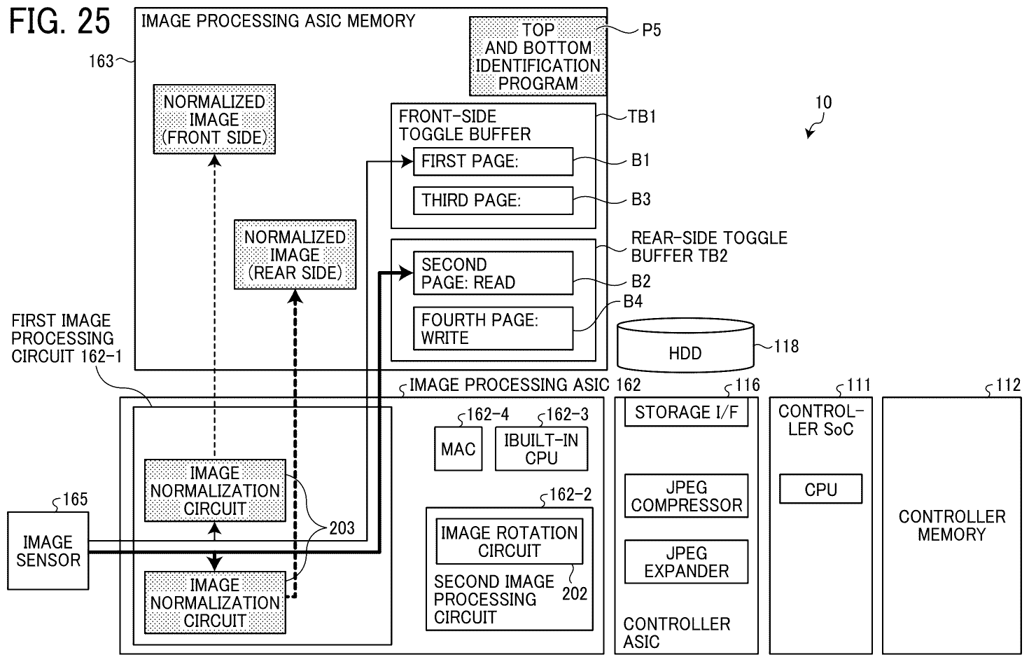

FIG. 25 is a diagram illustrating an example of the operational overview of the image reading device 10 according to the seventh embodiment in the reading process. FIG. 25 illustrates a configuration example of the seventh embodiment including a top and bottom identification program P5 in place of the top and bottom identification program P4 of the sixth embodiment, and including image normalization circuits 203 in the first image processing circuit 162-1.

In the sixth embodiment, the normalized image is generated with the top and bottom identification program P4. According to the top and bottom identification program P5 of the seventh embodiment, on the other hand, each of the image normalization circuits 203 of the first image processing circuit 162-1 generates the normalized image to reduce the load on the built-in CPU 162-3 of the image processing ASIC 162 and increase the processing speed of the built-in CPU 162-3.

The image processing ASIC 162 writes the normalized image generated by the image normalization circuit 203 to the image processing ASIC memory 163. According to the top and bottom identification program P5, the normalized image generated by the image normalization circuit 203 is used to make inference with a model that has learned for top and bottom identification, to thereby derive a top and bottom identification result.

An eighth embodiment of the present invention will be described.

The following description of the eighth embodiment will focus on differences from the first to seventh embodiments, and description of similarities thereto will be omitted.

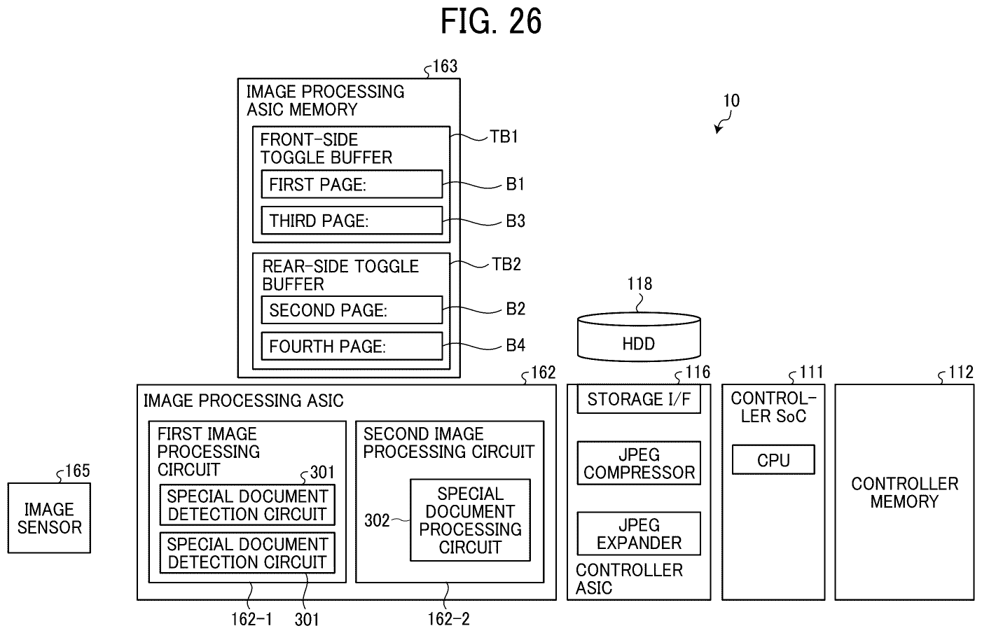

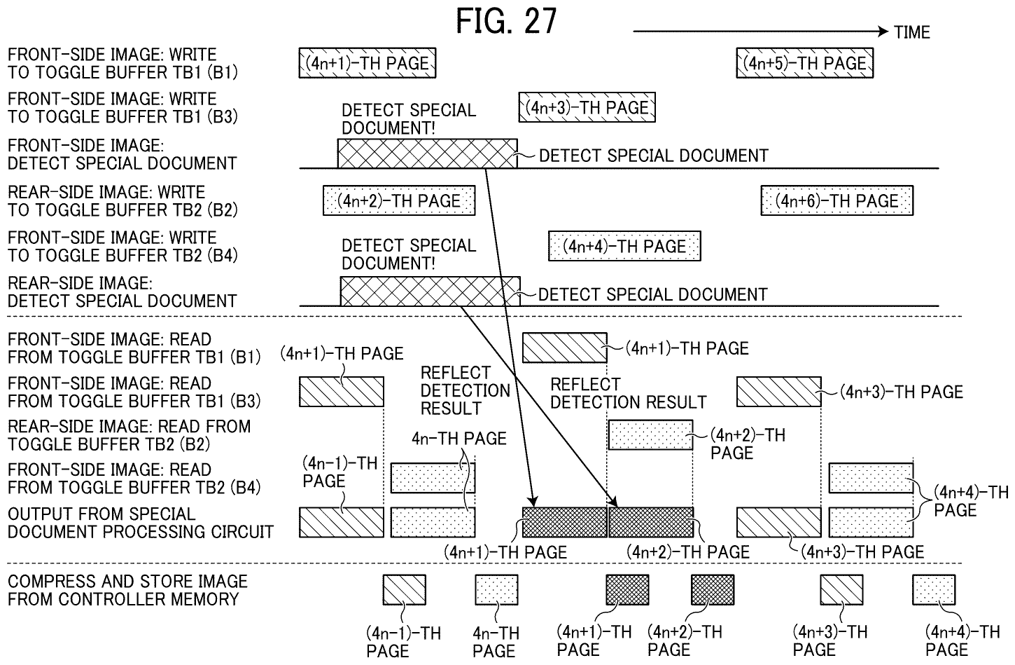

FIG. 26 is a diagram illustrating an example of the operational overview of the image reading device 10 according to the eighth embodiment in the reading process. FIG. 27 is a timing chart illustrating an operation of the image reading device 10 according to the eighth embodiment in the reading process.

The first to seventh embodiments use the toggle buffers in the single-path two-side (or one-side) image reading operation to improve the productivity in the reading process of the image reading device 10. Particularly in the second to seventh embodiments, the use of the toggle buffers improves the productivity in the subsequent processing with the feature value derived from the entire image, as compared with a configuration using single buffers.

The eighth embodiment, on the other hand, enables the image to be generated as intended, as compared with the background-art image reading device 500.

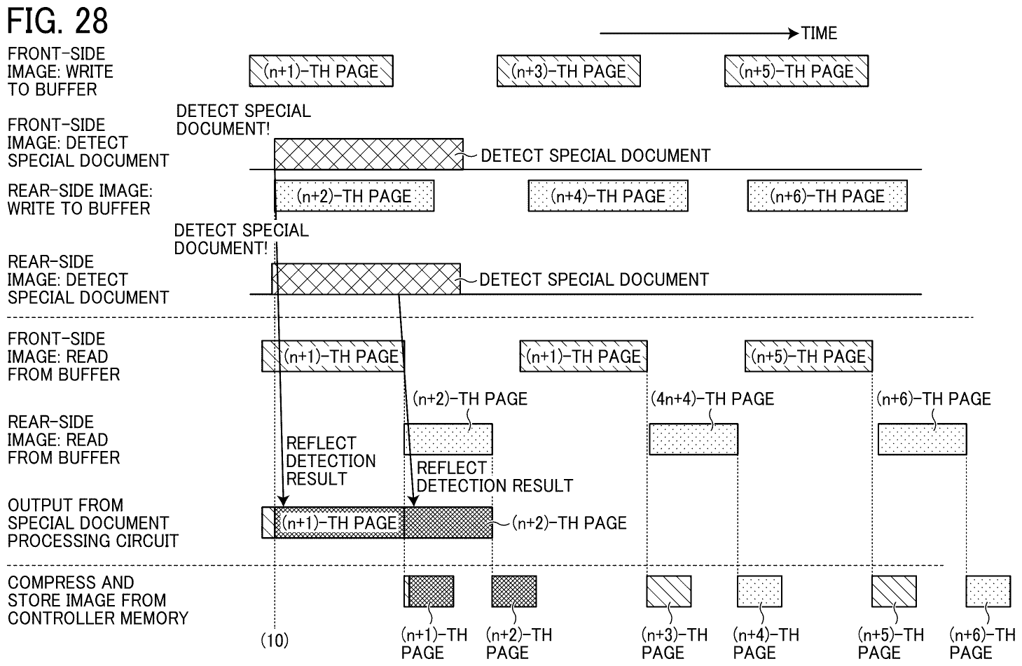

FIGS. 26 and 27 illustrates a configuration in which the top and bottom identification circuits 201 and the image rotation circuit 202 of the above-described second embodiment (see FIGS. 10 and 11) are replaced by special document detection circuits 301 and a special document processing unit 302, respectively. FIG. 28 is a timing chart illustrating an operation of a comparative example in which the front-side toggle buffer TB1 and the rear-side toggle buffer TB2 in the image reading device 10 of the eighth embodiment are replaced by single buffers as in the background-art image reading device 500.

Each of the special document detection circuits 301 is a special document detection unit that performs a search through the entire input image, and if a particular search result is obtained, determines that a special document has been detected.

The special document processing circuit 302 is a special document processing unit that outputs a special document output result when any of the special document detection circuits 301 detects a special document.

As illustrated in FIG. 28, in the background-art image reading device 500, when any of the special document detection circuits of the first image processing circuit 502-1 detects a special document, the detection result is transmitted to the special document processing circuit. The special document processing circuit then performs a process such as outputting a black image regardless of the image read from the corresponding buffer. In the comparative example, however, the data writing to a buffer and the data reading from the buffer are simultaneously performed. When it is determined that the special document is detected at a time (10) in FIG. 28, therefore, the currently read document has already partially passed through the special document processing circuit. Consequently, the image of a portion of the document that passes through the special document processing circuit after the time (10) is output as a solid black image, i.e., the image of the front side of the document is not output entirely in black.

According to the eighth embodiment, on the other hand, special document detection information has been determined at the time of reading from the buffer, as illustrated in FIGS. 26 and 27. Therefore, the data of the image is reflected in the processing of the special document processing circuit 302 of the second image processing circuit 162-2 from the top of the image, enabling the images of the front and rear sides of the document to be output entirely in black.

As described above, according to the eighth embodiment, the special document is appropriately processed in both the output of the front-side image and the output of the rear-side image, while it is difficult in the comparative example not using toggle buffers to appropriately process the special document, i.e., an initial portion of the front-side image of the special document in the sub-scanning direction fails to be output in black.

In the above-described embodiments, an image forming apparatus of the present invention is applied to an MFP with at least two functions output of the copier function, the printer function, the scanner function, and the FAX function. The present invention is also applicable to any image forming apparatus such as a copier, a printer, a scanner, or a FAX machine.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An image reading device comprising:
an image processing circuit configured to receive a plurality of read images input from an image sensor, the plurality of read images including a front-side image and a rear-side image for each page of a plurality of pages of a document read by the image sensor; and
a memory having a first memory area for storing the front-side image and a second memory area for storing the rear-side image,
the image processing circuit including:
a first image processing circuit configured to perform first image processing on one of the front-side image and the rear-side image, and alternately store, for each of the plurality of pages of the document, the front-side image in the first memory area and the rear-side image in the second memory area; and
a second image processing circuit configured to perform second image processing on the one of the front-side image and the rear-side image on which the first image processing is performed, being read from the memory,
the image processing circuit being configured to perform, in parallel, writing the plurality of read images on which the first image processing is performed to the memory and reading the plurality of read images from the memory to perform the second image processing on the plurality of read images.

2. The image reading device of claim 1, wherein the first image processing circuit performs the first image processing on the front-side image and the rear-side image, and
wherein the second image processing circuit performs the second image processing on the front-side image and the rear-side image on which the first image processing is performed.

3. The image reading device of claim 1, wherein in the first image processing, the first image processing circuit determines that a special document has been detected when a particular search result is obtained from a search through entirety of each read image of the plurality of read images input from the image sensor, and
wherein in the second image processing, the second image processing circuit outputs a special document output result in response to the detection of the special document.

4. The image reading device of claim 1, wherein in the first image processing, the first image processing circuit extracts a feature value from entirety of each read image of the plurality of read images, the read image being stored in the memory or being input from the image sensor but yet to be written to the memory, and
wherein the second image processing circuit reflects the extracted feature value in the second image processing.

5. The image reading device of claim 4, wherein the first image processing circuit extracts a top and bottom identification result as the feature value, the top and bottom identification result identifying a top and a bottom of the read image, and
wherein the second image processing circuit rotates the read image based on the extracted top and bottom identification result.

6. The image reading device of claim 5, wherein based on a normalized image generated from the read image stored in the memory with an inference model for top and bottom identification, the first image processing circuit performs inference with a model to derive the top and bottom identification result, the model having learned for top and bottom identification.

7. The image reading device of claim 6, wherein the first image processing circuit generates the normalized image from the read image stored in the memory with the inference model for top and bottom identification.

8. An image forming apparatus comprising:
the image reading device of claim 1; and
an image forming device to form an image based on each of the plurality of read images.

9. An image processing method comprising:
receiving a plurality of read images input from an image sensor, the plurality of read images including a front-side image and a rear-side image for each of a plurality of pages of a document read by the image sensor;
performing first image processing on one of the front-side image and the rear-side image;
alternately storing, for each of the plurality of pages of the document, the front-side image and the rear-side image in a memory having a first memory area that stores the front-side image and a second memory area that stores the rear-side image;
performing second image processing on the one of the front-side image and the rear-side image on which the first image processing is performed, being read from the memory; and
performing, in parallel, writing the plurality of read images on which the first image processing is performed to the memory and reading the plurality of read images from the memory to perform the second image processing on the plurality of read images.

10. The image processing method of claim 9, wherein the performing the first image processing includes performing the first image processing on the front-side image and the rear-side image, and
wherein the performing the second image processing includes performing the second image processing on the front-side image and the rear-side image on which the first image processing is performed.

11. The image processing method of claim 9, wherein the performing the first image processing includes determining that a special document has been detected when a particular search result is obtained from a search through entirety of each read image of the plurality of read images input from the image sensor, and
wherein the performing the second image processing includes outputting a special document output result in response to the detection of the special document.

12. The image processing method of claim 9, wherein the performing the first image processing includes extracting a feature value from entirety of each read image of the plurality of read images, the read image being stored in the memory or being input from the image sensor but yet to be written to the memory, and
wherein the performing the second image processing includes reflecting the extracted feature value in in the second image processing.

13. The image processing method of claim 12, wherein the performing the first image processing includes extracting a top and bottom identification result as the feature value, the top and bottom identification result identifying a top and a bottom of the read image, and
wherein the performing the second image processing includes rotating the read image based on the extracted top and bottom identification result.

14. The image processing method of claim 13, wherein the performing the first image processing includes, based on a normalized image generated from the read image stored in the memory with an inference model for top and bottom identification, performing inference with a model to derive the top and bottom identification result, the model having learned for top and bottom identification.

15. The image processing method of claim 14, wherein the performing the first image processing includes generating the normalized image from the read image stored in the memory with the inference model for top and bottom identification.
